(19) United States
(12) Patent Application Publication
(10) Pub. No.: US 2021/0224930 A1
(43) Pub. Date: Jul. 22, 2021

(54) APPARATUS, SYSTEMS, AND METHODS FOR DETECTING, COLLECTING, AND ANALYZING FIELD MEASUREMENT DATA

(71) Applicant: Torin Drive International, LLC, Memphis, TN (US)

(72) Inventor: Hao He, Memphis, TN (US)

(21) Appl. No.: 17/156,285

(22) Filed: Jan. 22, 2021

Related U.S. Application Data
(60) Provisional application No. 62/964,258, filed on Jan. 22, 2020.

(51) Int. Cl. G06Q 50/08; G06T 7/50; G06T 7/70

(52) U.S. Cl. CPC G06Q 50/08; G06T 2207/10028; G06T 7/70; G06T 7/50

(57) ABSTRACT

A system is described that includes a mobile application for controlling a sensor in capturing a plurality of structures at an installation site, wherein the capturing includes aiming the sensor at a plurality of structures and scanning the plurality of structures, wherein the capturing detects depth data of the plurality of structures. The mobile application is configured to transmit the depth data of the plurality of structures to one or more applications. The one or more applications are configured to use the depth data for creating a three-dimensional electronic image of the plurality of structures, to present the three-dimensional electronic image of the plurality of structures through an electronic interface, and to provide an electronic measurement tool for generating at least one distance measurement from a first point to a second point of the presented three-dimensional electronic image.

### RELATED APPLICATIONS

This application claims the benefit of U.S. App. No. 62/964,258, filed Jan. 22, 2020.

### TECHNICAL FIELD

The disclosure herein involves detecting, collecting, and analyzing measurement data in a construction site for equipment selection and installation.

### BACKGROUND

As part of an elevator installation and modernization project, technicians visit every site of a potential equipment installation and physically measure and document details of that specific site situation and application. This process requires temporary decommission of an elevator from service. The technician may climb on top of an elevator car to capture various measurements manually with a tape measure while transcribing the details. There is a need to automate this process.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 shows a general overview of a system for detecting, collecting, and analyzing field measurements, under an embodiment.

FIG. 2 shows a workflow for use of the FieldX App in detecting and collecting field measurements, under an embodiment.

FIG. 3 shows a login interface for the FieldX App, under an embodiment.

FIG. 4 shows an application page providing an interface for entering a new project, under an embodiment.

FIG. 5 shows a mobile device equipped with a structure sensor properly attached, under an embodiment.

FIG. 6 shows a list of on site scans, under an embodiment.

FIG. 7 shows a rope scan, under an embodiment.

FIG. 8 shows a rope scan, under an embodiment.

FIG. 9 shows a scan complete page, under an embodiment.

FIG. 10 shows a beam scan, under an embodiment.

FIG. 11 shows a beam scan, under an embodiment.

FIG. 12 shows a scan complete page, under an embodiment.

FIG. 13 shows a rope-to-wall scan, under an embodiment.

FIG. 14 shows a rope-to-wall scan, under an embodiment.

FIG. 15 shows a scan complete page, under an embodiment.

FIG. 16 shows an upload scans page, under an embodiment.

FIG. 17 shows electronic measurement of scan beam parameters, under an embodiment.

FIG. 18 shows electronic measurement of scan rope parameters, under an embodiment.

FIG. 19 shows electronic measurement of scan rope-wall parameters, under an embodiment.

FIG. 20 shows a plurality of shaftway and machine room measurements, under an embodiment.

FIG. 21 shows a machine room clearance height scan, under and embodiment.

FIG. 22 shows a machine room clearance height scan, under and embodiment.

FIG. 23 shows an electronic measurement of machine room clearance height, under and embodiment.

FIG. 24 shows a rope to wall scan, under and embodiment.

FIG. 25 shows a rope to wall scan, under and embodiment.

FIG. 26 shows an electronic measurement of rope to wall distance, under and embodiment.

FIG. 27 shows a machine room obstruction scan, under and embodiment.

FIG. 28 shows a machine room obstruction scan, under and embodiment.

FIG. 29 shows a machine room obstruction measurement, under and embodiment.

FIG. 30 shows a system for collecting field measurement data, under an embodiment.

### DETAILED DESCRIPTION

Field X Measure (also referred to as FX Survey) comprises a solution for performing field measurements for elevator equipment installations and modernization. The Field X Measure tool reduces time and labor costs for surveying the construction site, configuring the equipment, assisting installations, and collecting pertinent data. In doing so the Field X Measure tool automates the process of collecting construction site and equipment details and produces an output of technical data including ordering information for an end user. The Field X Measure system retains site dimensions and equipment and installation specific data for re-use in equipment modernizations, decades later.

The Field X Measure tool provides capabilities for measuring the same components of an elevator system with the use of an application running on a handheld smart device. The application and device measure/collect such data in a matter of minutes.

The solution software comprises a mobile client application that collects site data and a server that processes, manages, and displays the collected data. Information captured by the user on the mobile client is under an embodiment verified by a member of the Field X Measure team on the server.

A user uses under an embodiment a smartphone application to scan and capture point cloud data, which is then uploaded via the internet to Field X Measure servers and saved in Field X Measure back end databases. Project managers may then examine the data using a point cloud viewer available through a website accessible to said managers. The project manager opens the point cloud data stored in the server database and the viewer loads up the data to display the measured objects as 3-dimensional images. The viewer allows a user to zoom in and out, rotate, and pan the image to validate the collected data. The user verifies that the scan looks correct and captures the area that includes target measurement data.

The information is then used for the purpose of completing an application survey for that project. The survey comprises a form already present on a website that contains various parameters for an elevator, such as capacity, speed, the distance between two beams, etc. The smartphone application uploads collected data to the server database. A Server Management system (referred to as a FieldX Server) includes one or more applications running on a server for receiving collected data. The FieldX Server uses information of collected items to automatically extract relevant data from the elevator parameter database to fill in the entire survey/form.

The survey form detail is used in matching the proper equipment to the application, including necessary components and connections, and issuing a quotation with pricing detail for the purpose of ordering the equipment and ultimately installing the equipment. Elevator equipment is assembled on-site. The requirements for the equipment include not only the application needs of the client but also the parameters of the physical environment of the assembling site. The on-site data collected by the smartphone application is used to generate the survey form, which in turn provides the reference for equipment manufacturing in the factory. The process ensures that the resulting equipment matches the demands of the assembling site.

The mobile client software captures site information along with image and depth data using the Structure Sensor developed by Occipital™ that attaches to an iPhone™ or iPad™ with a custom phone case and lightning cable. The phone case is customized to ensure secure fixation of the structure sensor. Once attached to the phone, the structure sensor needs calibration for precise depth measurement. The sturdy phone case ensures a completely fixed relative position between the phone and the calibrated structure sensor.

The mobile software has been developed specifically for the iPhone in the Swift programming language and uses the Occipital™ SDK to communicate with the sensor. The Structure senor uses an infrared pattern of dots out in front of it, and the infrared camera uses that pattern of dots to visualize the shape and distance of objects. The projection is done with a dedicated infrared laser projector. Operation of the Occipital™ Structure Sensor is described in U.S. Pat. No. 9,438,775 which is incorporated herein by reference in its entirety.

The Structure Sensor is equipped with two Infrared Cameras, one Ultra-wide Vision Camera, and one Laser Dot Projector. An Infrared camera is a device that creates an image using infrared radiation, similar to a common camera that forms an image using visible light. The art of capturing and analyzing the data they provide is called thermography. These cameras work together, not only to capture two-dimensional data, but also depth data, this is called “3D scanning”. The scanning process is described in U.S. Pat. No. 9,438,775 which is incorporated herein by reference in its entirety. The Structure Sensor Software Development Kit (SDK) is published with the Structure Sensor hardware. Mobile App software may call/invoke the Application Programming Interface (API) provided by SDK, then the software drives the cameras to scan and retrieve data generated. The data is stored on the mobile phone and is then uploaded to server, classified by users and projects.

Alternatively, image and depth data can be captured using the LiDAR Sensor available on iOS devices from Apple. Currently the iPhone Pro 12™, iPhone Pro 12 Max™, and iPad Pro™ use the LiDAR Sensor. As with the above-mentioned sensor, the image and depth data are used to construct a 3D scene referred to as a process of “3D scanning” through bouncing light to determine the distance of an object from the sensor. The operation of the LiDAR sensor implemented by Apple™ is described in U.S. Pat. No. 10,324,171 which is incorporated herein by reference in its entirety. Under an embodiment, the data is stored on the mobile phone and is then uploaded to the server, classified by users and projects.

The client software provides users a methodology for defining a project along with a site location. Once a site location is established, a user is guided through collecting image and depth data for a number of key measurements, including beam and rope information.

The collected image and depth data are stored as a Point Cloud of 3D data points along with its RGBD information. The RGBD (or red green blue along with depth data) allow a 3D reconstruction. The reconstruction is later used so distances can be measured between features such as beam height, beam distance, rope-to-rope etc. That data is then uploaded to a server for additional processing and management.

The server component of the solution stores and manages the information collected by the client application. The server component is developed in python 3.5 using Flask framework running on Linux (Ubuntu 16.04). The server also employs SQLite for data storage. The server data is managed through a custom web-based admin tool that organizes collected field measurements by projects and sites and includes a web viewer for collected depth and image data or point cloud data. When an image and depth data is uploaded to the server from the mobile client, the server software processes the data to look for specific elements such as a wall, ceiling, rope and or beam. The image and RGBD or point cloud data is run through a series of algorithms to look for unique features such as walls, ropes and beams. These feature points are then annotated as geometric shapes that can be displayed to the user through the web interface.

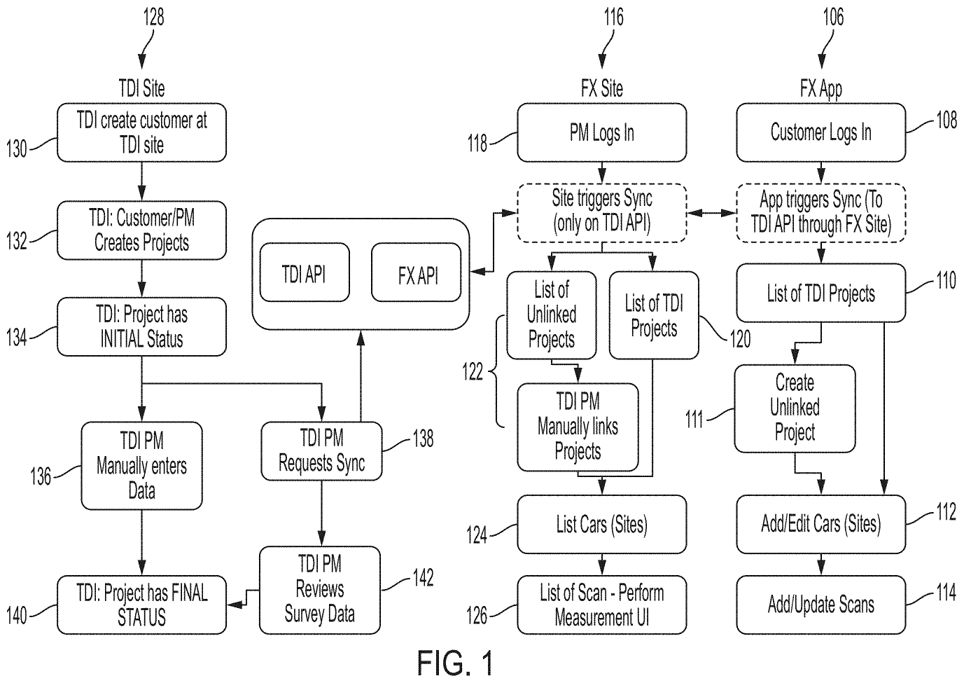

FIG. 1 shows a general overview of a Field X system of detecting, collecting, and analyzing field measurements, under an embodiment. Note that TDI stands for Torin Drive International.

The survey solution described above comprises a number of components to aid a user in completing a measurement survey for a project site of elevator cars and their corresponding shaftways (also referred to as hoistways) and machine rooms. The main components are shown in FIG. 1. The survey solution comprises a Customer Management System (referred to as the TDI Server) 128, a Survey Management System (FieldX Server) 116, and a Survey Client iPhone Application (referred to as the FieldX App) 106.

The Customer Management System (TDI Server) is where client/project information is stored.

The Survey Management System (FieldX Server) comprises a web-based admin tool that stores all the collected information for the FieldX App and allows a user to complete measurements in a web-based 3D measurement tool.

The Survey Client iPhone App (FieldX App) runs on a modern iPhone with an attached Occipital™ Structure Sensor. Note that the client application may run on alternative mobile devices including laptops, smartphones, tablets, wearable computing devices, etc. Such devices may run iOS™, Android™, Microsoft™, or Linux™ operating systems.

In completing a measurement survey, a user employs the FieldX App to capture scans of specific elevator measurements. Those collected scans are then uploaded to the FieldX Server where a user or Project Manager (PM) may then assign detailed measurements to the collected scans. Once assigned a site survey a report may be created as further described below.

Before a user travels to a project site to conduct a survey, company information is set up in the TDI Server 130 as seen in FIG. 1. Then a project is setup in the TDI server 132 along with basic location information and its status is set to INITIAL 134. For the case of this example we shall refer to this project as the ACME Building.

Note that at TDI API and FieldX API provide a communicative coupling between the TDI Server and FieldX Server. The FieldX App then communicates with the FieldX Server and with the TDI Server through the FieldX Server. Accordingly, the TDI Server forwards projects to the client application through the FieldX Server.

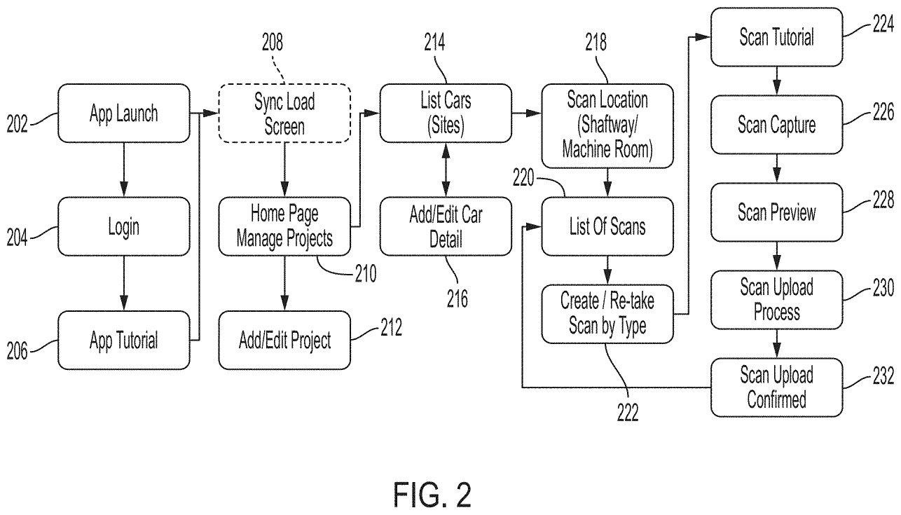

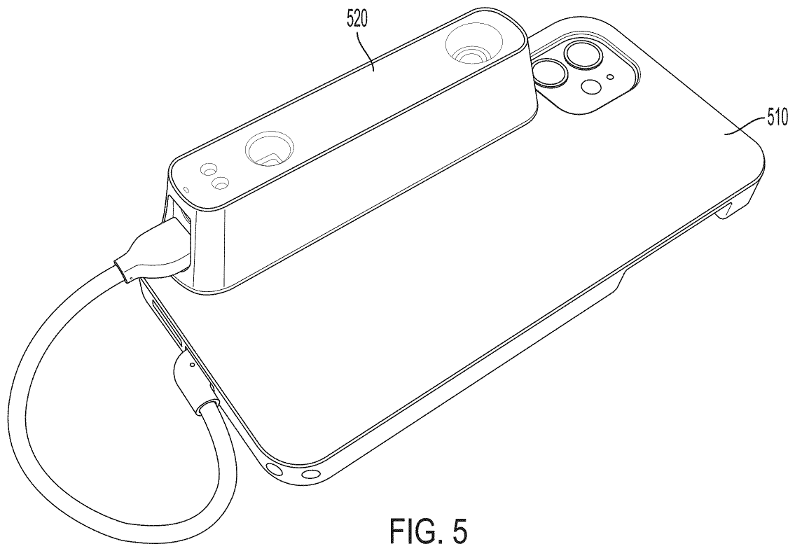

The user then travels to the location of the ACME Building with an iPhone™ running the FieldX App and equipped with an Occipital™ Structure Sensor properly attached. FIG. 5 shows an iPhone™ 510 running the FieldX App and equipped with an Occipital™ Structure Sensor 520 properly attached. As indicated above, alternative sensors may be used. FIG. 2 shows a workflow for use of the FieldX App in detecting and collecting field measurements, under an embodiment.

FIG. 2 illustrates on site use of the FieldX app, under an embodiment. At the location the user initiates the FieldX App 202 and logs in with an assigned username and password 204. The user may initially be presented with an application tutorial 206. (Note that element 208 simply indicates that projects from both the TDI Server and FieldX Server are synced with the client application).

After viewing or bypassing the tutorial, a user is then presented with a home page 210 which presents the projects currently managed by the user. A user may then select the ACME Building project in order to continue work on such project. The home page also allows a user an option 212 to add projects or edit open projects.

A user is then presented 214 with a list of Elevator Cars present at the selected site. A user may select a Car or add 216 an Elevator Car for survey. At this point the user enters/updates Car information in the app to include the following:

Roping Ratio

Deflector above or below slab

Machine beam configuration

Concrete Slab thickness

Geared or gearless existing

Right or left hand configuration

Number of Ropes

Bottom of Machine room floor to center of deflector sheave

Groove Pitch

Once a user has completed details on the Car information they are then prompted by the FieldX App to conduct measurement surveys. A user can select either the machine room or the shaftway 218. Under one embodiment, a user selects from scan menu 220 the Shaftway Scan option. The user then generates 222 the following scans:

Beam—Height

Beam—Width

Beam to Beam

Beam Edge to rope center

Rope to Rope

Rope to Wall

For Machine Room, scans options are:

Machine room Height Clearance

Rope to Wall

Obstructions

Deflector Sheave Diameter

Again for this example, the user may start with the “Beam-Beam” scan in the Shaftway and selects this option 222 in the FieldX App which initiates the process of creating the particular type of scan. The app instructs the User how to perform the scan with a number of visual tutorials 224 illustrating where to stand and how to aim the camera during a scan. Following the tutorial, a user performs a three-dimensional capture 226 by aiming the scanner at the beams at the top of shaftway and pressing the “record” scan button.

When a user performs a scan, the attached sensor captures the depth data of the area where the sensor is aimed. This data is stored as a Point Cloud which comprises thousands of points in 3D space that are stored as RGBD format (Red, Green, Blue, and Depth—Depth is defined in x,y,z coordinates).

Upon completing the scan, a user is shown a 3D scan preview 228 of the captured Point Cloud. The user verifies that the FieldX App has captured the beams in the scan and selects next. On the next screen of the app a user is prompted to upload 230 the scan to the FieldX Server. The user selects upload and the FieldX App provides user with confirmation 232 of the upload process. The FieldX Server software then processes the uploaded scan data.

In processing the Point Cloud, the server software looks for planes (i.e. walls and ceiling), beams and ropes. Unique algorithms look for these features by processing the 3D points so see how they are organized. A plane is determined if enough points align a 3-Point plane. A Beam is identified by looking for planes that are long, narrow, and distanced from a ceiling plane. Ropes (cables) are identified by looking for narrow, long clusters of 3D points that would identify as a tube.

As one example, beams are found under the assumption that X space is left to right, Y space is up and down, and Z space is depth—back and forth:

1. The wall and ceiling planes are identified first. Again these planes are found by processing points that exist in a certain density along a 3 point plane. A criteria for walls (in the Y, X plane) and ceilings (in the Z, X plane) are the existence of a minimum percentage of a concentration of points. A percentage of points may be defined as a percentage of cloud points that exist in a plane. As just one example, a wall may be identified as a plane amongst a plurality of identified planes with the highest percentage of points along such plane relative to the plurality of identified planes. Accordingly, a box on a wall does not get identified as a wall.

2. Because the capture process includes gravity the application knows the Y Space direction so the algorithm looks for a plane in the Z, X plane, i.e. looks for a point concentration with sufficient coverage of the captured area.

3. Beams are then sought to be identified as planes also in the Z, X plane that represent a smaller concentration than the ceiling and are long and narrow as well as a distance in the Y direction from the identified ceiling plane. A smaller concentration means that the plane of the beams does not represent as much surface area as the ceiling and thus can be distinguished.

4. Ropes are then identified by looking for a tubular concentration of depth information that runs the up/down or “Y” axis and exists independently of a large surface.

When the above referenced features are identified the application makes a file that accompanies the Point Cloud in a JavaScript Object Notation file that has the associated geometries of any identified Planes, Beam and Ropes. JavaScript Object Notation (JSON) is an open-standard file format or data interchange format that uses human-readable text to transmit data objects consisting of attribute-value pairs and array data types (or any other serializable value). This information will be used later when the user employs the web-based 3D viewing tool to attach measurements to the scan.

In the FieldX app, the user repeats the above process for all the remaining Shaftway and Machine room scans. Once all these scans have been completed and uploaded to FieldX Server, the User flags the project for scans complete on the FieldX App. This will notify a TDI project manager (PM) that measurements need to be completed. This action changes the project status to “processing.”

Note that FIG. 1 provides an overview of the workflow described above. As seen in FIG. 1, a user logs in 108 to the application, views projects 110 (or creates a project 111), adds/edits cars 112, and generates scans 114.

The PM may log into the FieldX Server web site 118, select a surveyed project 120 (or manually link 122 a client created project to a customer), select a car 124, and open the collected scans 126 one at a time. In each scan the PM loads in the 3D point cloud in a tool that allow the PM to draw two points in 3D space to complete a measurement. The PM will repeat this process until measurements have been assigned to all the Shaftway and Machine room scans. The user draws these points using a web interface. This web interface allows the user to bring up the 3D scan data in a viewer that allows user to pan, rotate and zoom the object. The cursor identifies a point in 3D space. The user adds a measurement by selecting a measurement type (i.e. rope-to-rope) then clicking the first measurement point and then the end measurement point in 3D space. The viewer displays the distance from these two points in inches. That measurement is then saved for future reference. Under one embodiment, the FieldX Server includes one or more applications that implement machine leaning to recognize the image and patterns and capture the desired dimensions automatically.

The PM flags the project as “survey complete”. The FieldX server creates a downloadable PDF report of the completed project survey and measurements as well as make the information available to the TDI Server via an API.

As seen in FIG. 1, the TDI Server receives 138 project survey data from the FieldX Server. The PM reviews the survey data 142 and may mark the project with FINAL STATUS 140. A PM may manually add data 136 for storage alongside the project survey data.

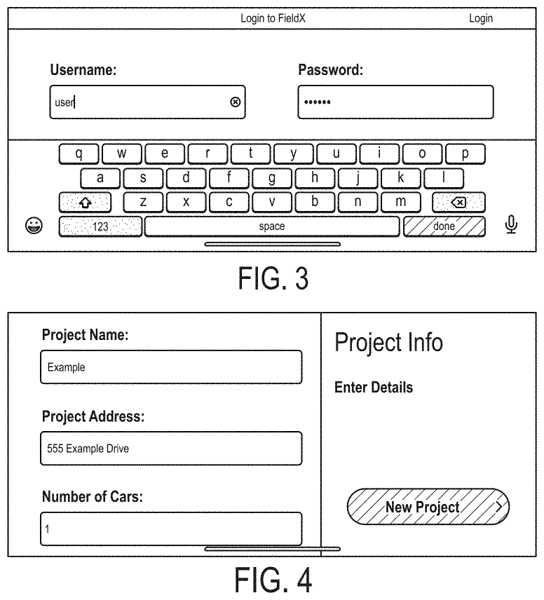

FIG. 3 shows a login interface for the FieldX App, under an embodiment.

FIG. 4 shows an application page providing an interface for entering a new project, under an embodiment.

FIG. 5 shows an iPhone™ 510 running the FieldX App and equipped with an Occipital™ Structure Sensor 520 properly attached. As indicated above, alternative sensors may be used.

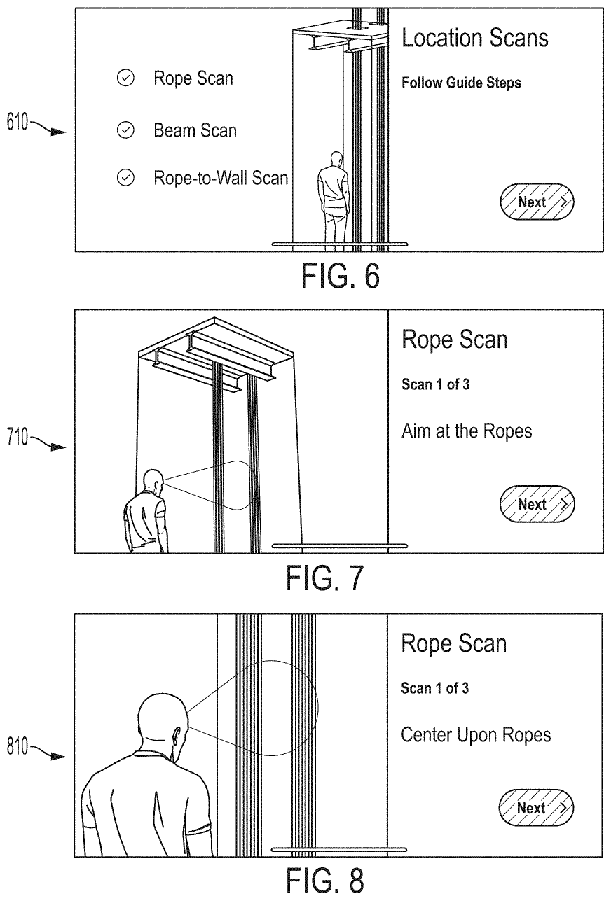

FIGS. 6-20 show a user navigating the application to generate Shaftway scans and measurements, under an embodiment.

FIG. 6 shows a list of on site scans 610, under an embodiment. The list includes a rope scan, a beam scan, and a rope-to-wall scan.

FIG. 7 shows a rope scan 710, under an embodiment. The interface directs a user to aim the camera at the ropes. The interface provides visual camera directions from the perspective of an on screen animated user. The user selects a next button to advance the scan.

FIG. 8 shows a rope scan 810, under an embodiment. The interface directs a user to center the camera upon the ropes. The interface provides visual camera directions from the perspective of an on screen animated user. The user selects a next button to advance the scan.

The screen shots corresponding to rope scans described above may instruct to user to ensure a camera position that captures both sets of ropes. They may also instruct a user to pan the camera right and left to capture both sets of ropes.

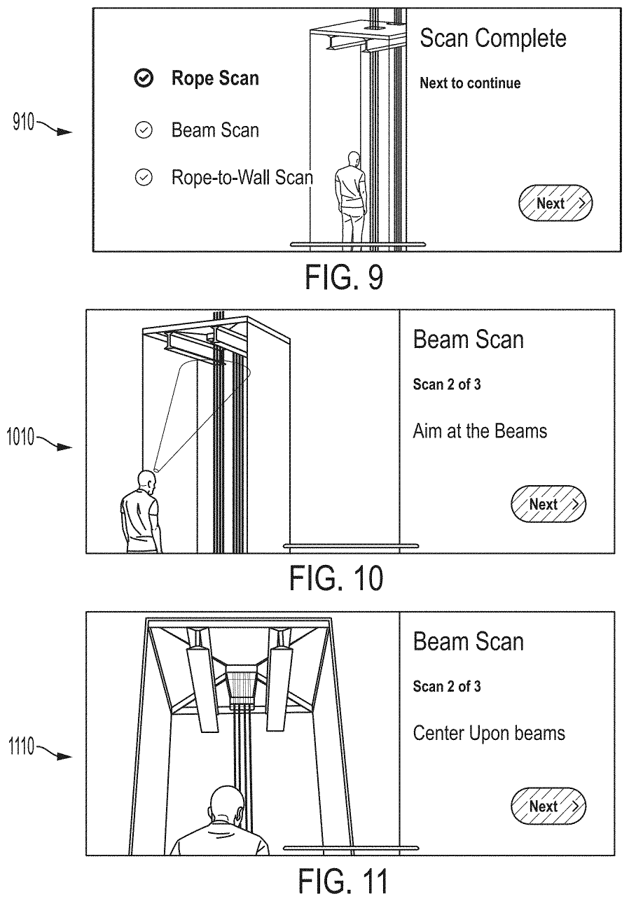

FIG. 9 shows a scan complete page 910, under an embodiment. The figure illustrates that the rope scan (appearing in bold) is complete. The figure indicates that the beam scan and rope-to-wall scan are still pending.

FIG. 10 shows a beam scan 1010, under an embodiment. The interface directs a user to aim the camera at the beams. The interface provides visual camera directions from the perspective of an on screen animated user. The user selects a next button to advance the scan.

FIG. 11 shows a beam scan 1110, under an embodiment. The interface directs a user to center upon the beams. The interface provides visual camera directions from the perspective of an on screen animated user. The user selects a next button to advance the scan.

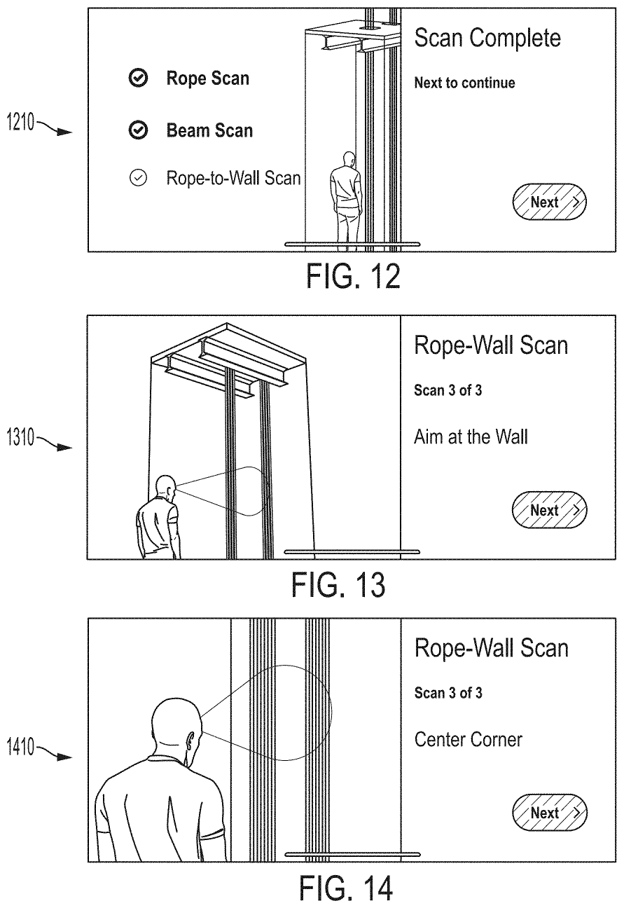

FIG. 12 shows a scan complete page 1210, under an embodiment. The figure illustrates that the rope scan and beam scan (appearing in bold) are complete. The figure indicates that rope-to-wall scan is still pending.

FIG. 13 shows a rope-to-wall scan 1310, under an embodiment. The interface directs a user to aim the camera at the wall. The interface provides visual camera directions from the perspective of an on screen animated user. The user selects a next button to advance the scan.

FIG. 14 shows a rope-to-wall scan 1410, under an embodiment. The interface directs a user to “Center Corner” which is an instruction to frame a corner in the center of a view. A “center corner” instruction ensures that a user captures at least two-walls and the ceiling of a shaftway in a scan. The interface provides visual camera directions from the perspective of an on screen animated user. The user selects a next button to advance the scan.

Note that the rope-to-wall scan may under an embodiment may be conducted as a machine room scan. Such embodiment is further described below.

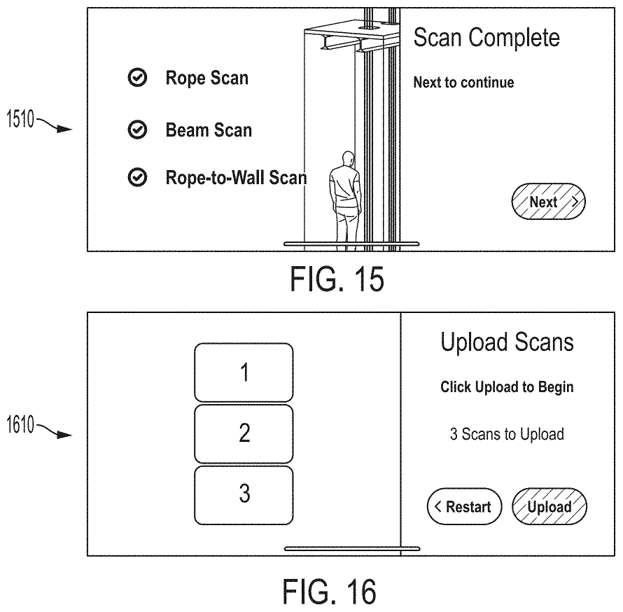

FIG. 15 shows a scans complete page 1510, under an embodiment. The figure indicates completion of scans. The user selects a next button to advance to the next screen.

FIG. 16 shows an upload scans page 1610 providing a user an opportunity to upload all scans, under an embodiment.

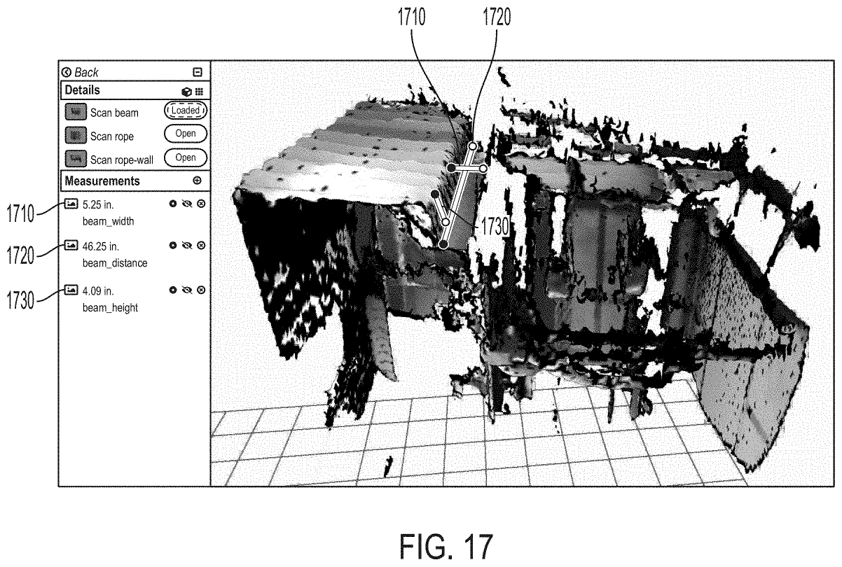

FIG. 17 shows electronic measurement of scan beam parameters, under an embodiment. The figure shows a 5.25 inch beam width 1710 measurement, a 46.25 inch beam distance 1720 measurement, and a 4.09 inch beam height measurement 1730. These measurements comprises 3D point to point measurements.

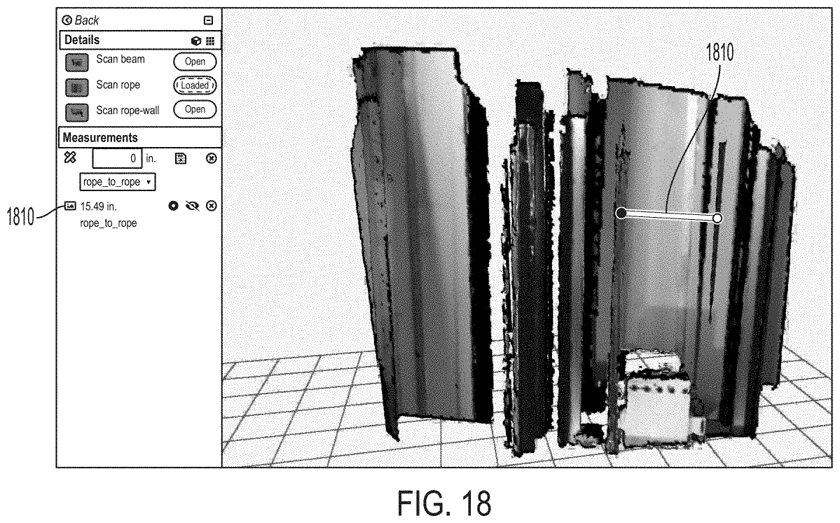

FIG. 18 shows electronic measurement of scan rope parameters, under an embodiment. The figure shows a 15.49 inch rope to rope measurement 1810. This measurement comprises a 3D point to point measurement.

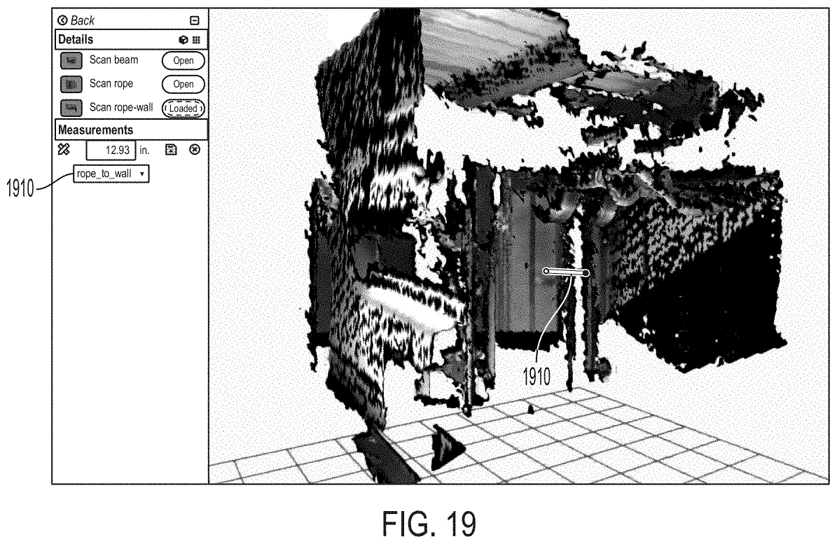

FIG. 19 shows electronic measurement of scan rope-wall parameters, under an embodiment. The figure shows a 12.93 inch rope to wall measurement 1910. This measurement comprises a 3D point to point measurement.

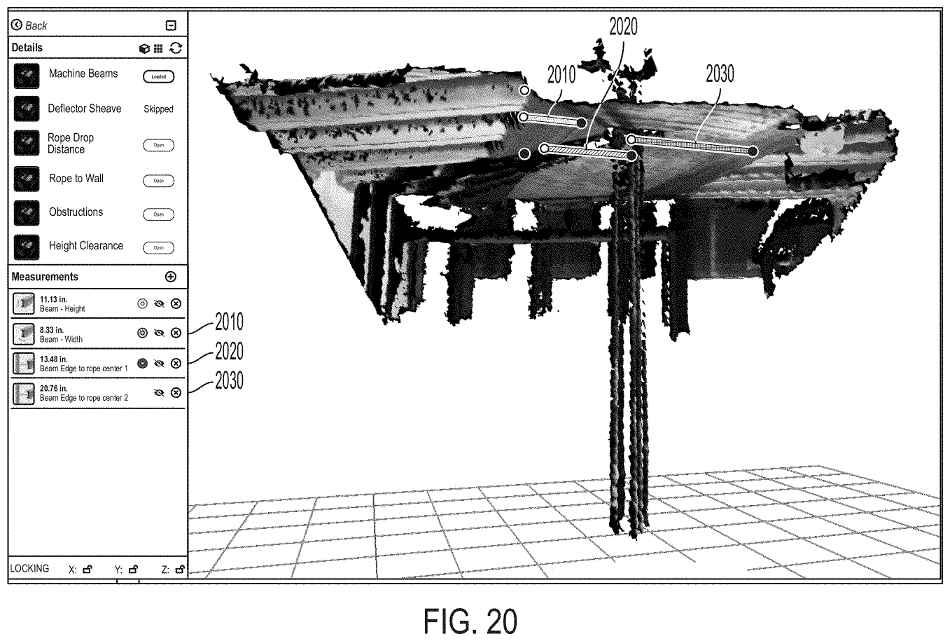

FIG. 20 shows a plurality of shaftway electronic measurements, under an embodiment. The figure shows an 8.33 beam width measurement 2010, a 13.48 inch beam edge to rope center 1 measurement 2020, and a 20.76 inch beam edge to rope center 2 measurement 2030. These measurements comprise 3D point to point measurements.

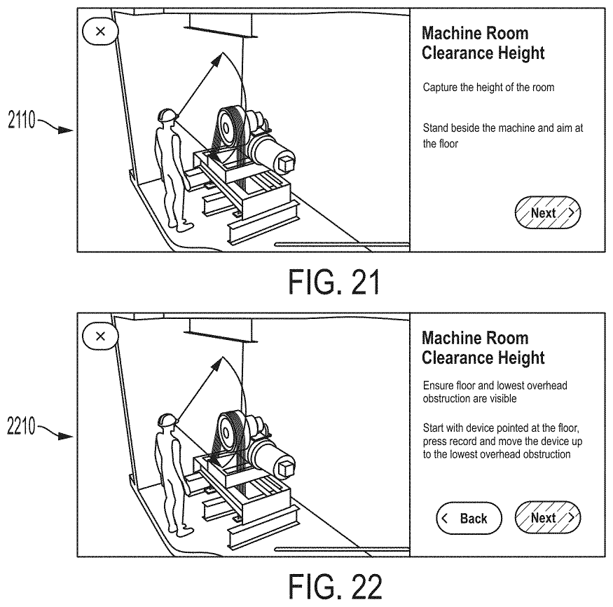

FIGS. 21-29 show user navigating the application to generate machine room scans and measurements, under an embodiment.

FIG. 21 shows a machine room clearance height scan 2110, under an embodiment. The interface directs a user to stand beside the machine and aim at the floor. The interface provides visual camera directions from the perspective of an on screen animated user. The user selects a next button to advance the scan.

FIG. 22 shows a machine room clearance height scan 2210, under an embodiment. The interface directs a user to start with the camera aimed at the floor. Once the scan is initiated, a user is directed to move the device to lowest overhead obstruction. As indicated on the screen, this process ensures that the floor and lowest overhead obstruction are visible. The interface provides visual camera directions from the perspective of an on screen animated user. The user selects a next button to advance the scan.

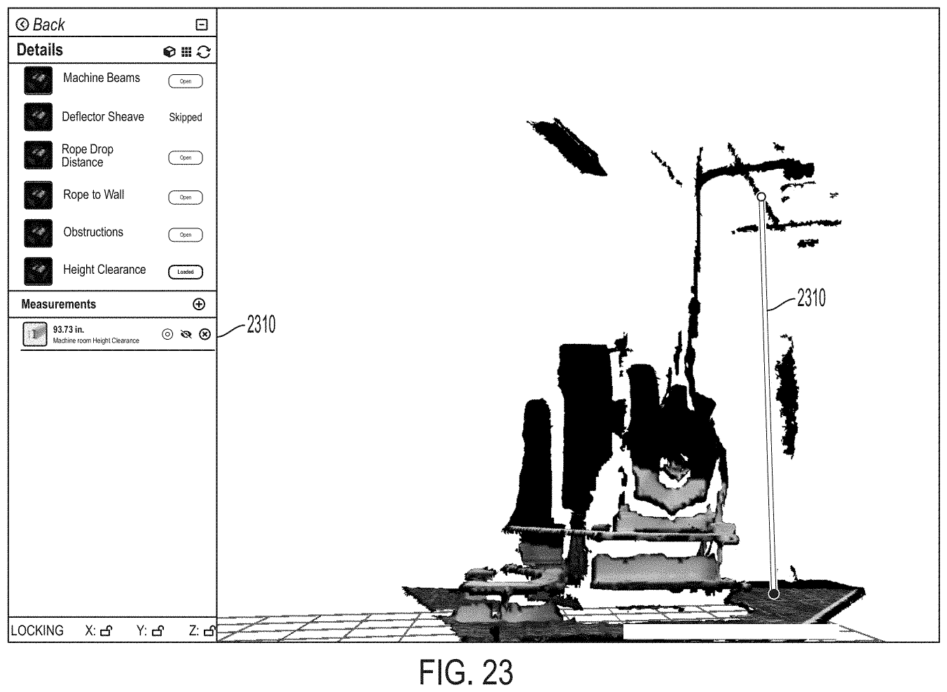

FIG. 23 shows a machine room height clearance measurement 2310 of 93.73 inches. This measurement comprises a 3D point to point measurement, under an embodiment.

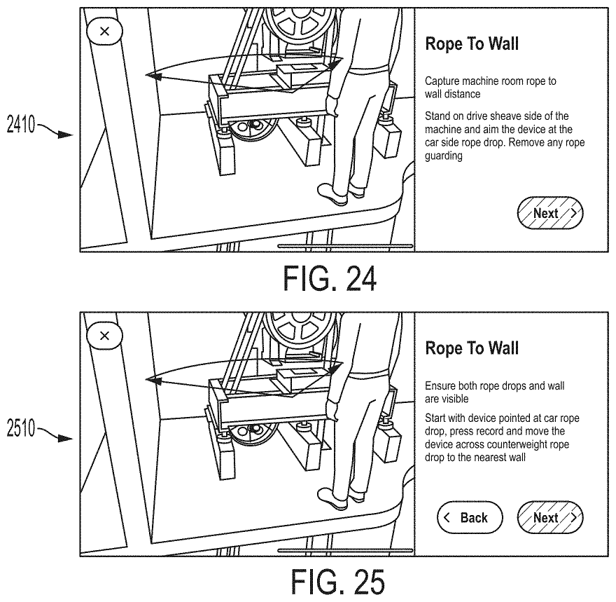

FIG. 24 shows a rope to wall scan 2410, under an embodiment. The interface directs a user to capture machine room rope to wall distance. The interface directs a user to stand on drive sheave side of the machine and aim the device at the care side rope drop and remove any rope guarding. The interface provides visual camera directions from the perspective of an on screen animated user. The user selects a next button to advance the scan.

FIG. 25 shows a rope to wall scan 2510, under an embodiment. The interface directs a user to ensure the camera captures both rope drops and wall. The interface directs a user to start with device pointed at car, press record and move the device across counterweight rope drop to nearest wall. The interface provides visual camera directions from the perspective of an on screen animated user. The user selects a next button to advance the scan.

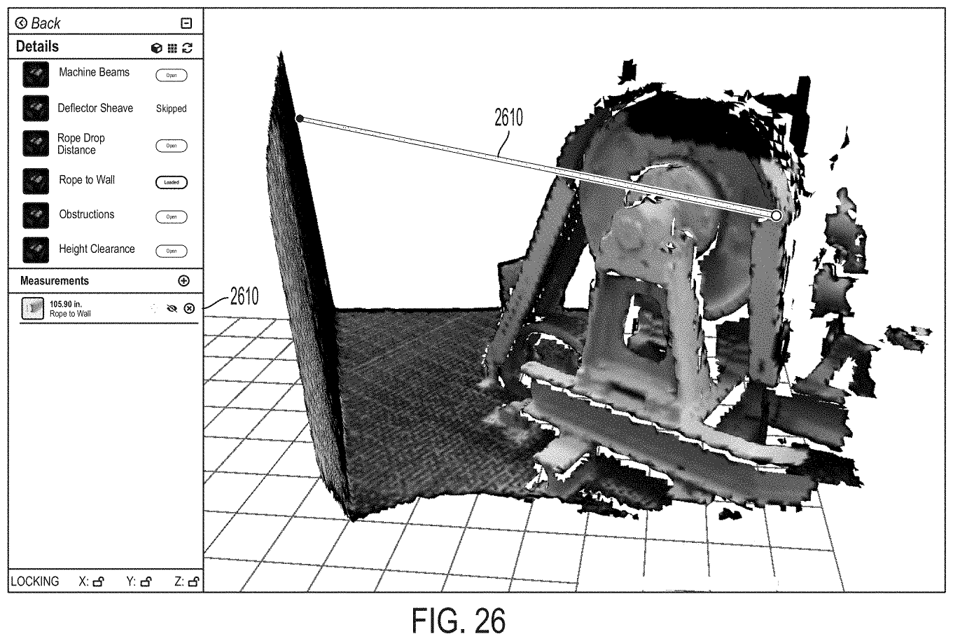

FIG. 26 shows a rope to wall measurement 2610 of 105.90 inches. This measurement comprises a 3D point to point measurement, under an embodiment.

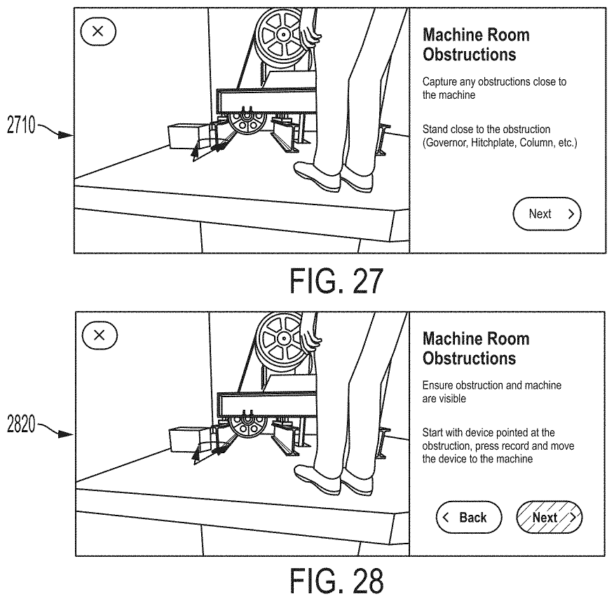

FIG. 27 shows a machine room obstruction scan 2710, under an embodiment. The interface directs a user to capture any obstructions close to the machine. The interface directs a user to stand close to the obstruction (e.g., governor, hitchplate, column, etc.). The interface provides visual camera directions from the perspective of an on screen animated user. The user selects a next button to advance the scan.

FIG. 28 shows a machine room obstruction scan 2820, under an embodiment. The interface directs a user to ensure that obstruction and machine are visible. The interface directs a user to start with device pointed at obstruction, press record, and move the device to the machine. The interface provides visual camera directions from the perspective of an on screen animated user. The user selects a next button to advance the scan.

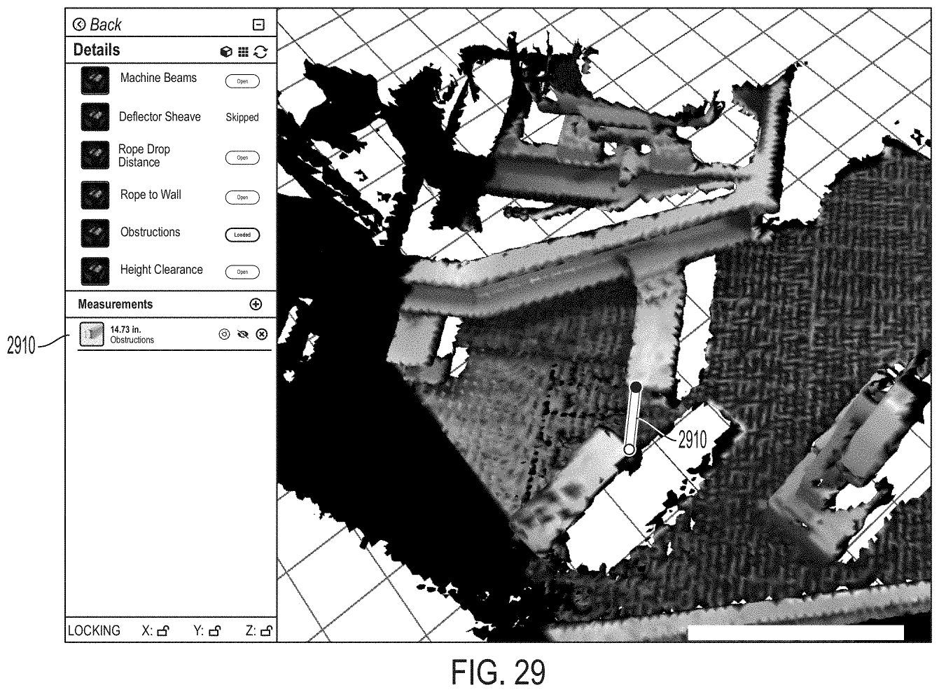

FIG. 29 shows a machine room obstruction measurement 2910 of 14.73 inches. This measurement comprises a 3D point to point measurement, under an embodiment.

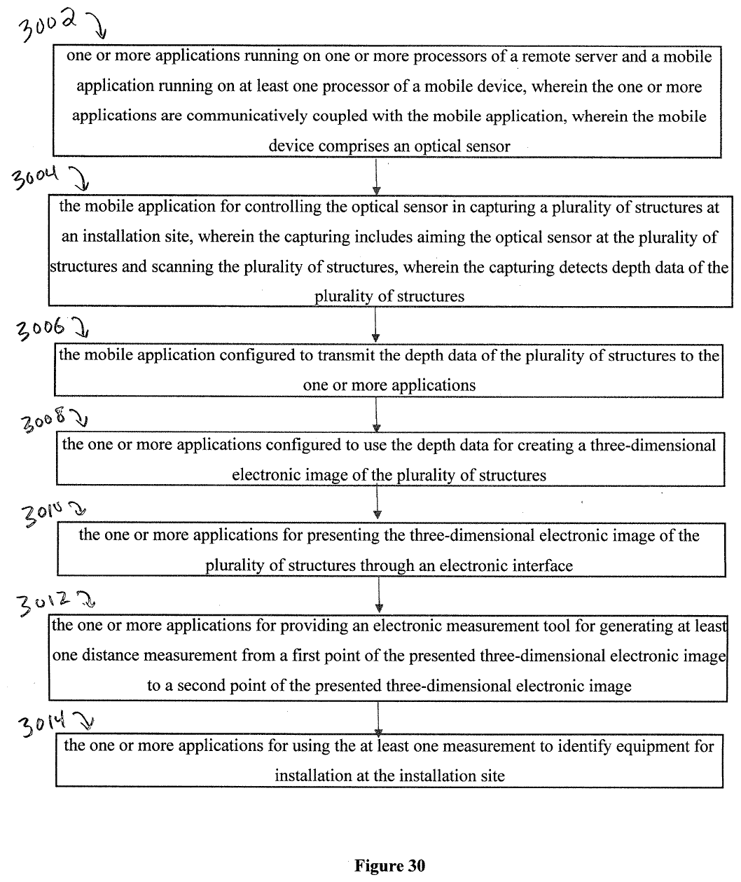

FIG. 30 shows a system for collecting field measurement data, under an embodiment. The system includes 3002 one or more applications running on one or more processors of a remote server and a mobile application running on at least one processor of a mobile device, wherein the one or more applications are communicatively coupled with the mobile application, wherein the mobile device comprises an optical sensor. The system includes 3004 the mobile application for controlling the optical sensor in capturing a plurality of structures at an installation site, wherein the capturing includes aiming the optical sensor at the plurality of structures and scanning the plurality of structures, wherein the capturing detects depth data of the plurality of structures. The system includes 3006 the mobile application configured to transmit the depth data of the plurality of structures to the one or more applications. The system includes 3008 the one or more applications configured to use the depth data for creating a three-dimensional electronic image of the plurality of structures. The system includes 3010 the one or more applications for presenting the three-dimensional electronic image of the plurality of structures through an electronic interface. The system includes 3012 the one or more applications for providing an electronic measurement tool for generating at least one distance measurement from a first point of the presented three-dimensional electronic image to a second point of the presented three-dimensional electronic image. The system includes 3014 the one or more applications for using the at least one measurement to identify equipment for installation at the installation site.

A system is described herein that comprises one or more applications running on one or more processors of a remote server and a mobile application running on at least one processor of a mobile device, wherein the one or more applications are communicatively coupled with the mobile application, wherein the mobile device comprises an optical sensor. The system includes the mobile application for controlling the optical sensor in capturing a plurality of structures at an installation site, wherein the capturing includes aiming the optical sensor at the plurality of structures and scanning the plurality of structures, wherein the capturing detects depth data of the plurality of structures. The system includes the mobile application configured to transmit the depth data of the plurality of structures to the one or more applications. The system includes the one or more applications configured to use the depth data for creating a three-dimensional electronic image of the plurality of structures. The system includes the one or more applications for presenting the three-dimensional electronic image of the plurality of structures through an electronic interface. The system includes the one or more applications for providing an electronic measurement tool for generating at least one distance measurement from a first point of the presented three-dimensional electronic image to a second point of the presented three-dimensional electronic image. The system includes the one or more applications for using the at least one measurement to identify equipment for installation at the installation site.

The capturing includes the mobile application instructing a directional positioning of the optical sensor by presenting visual direction through a mobile device electronic interface, under an embodiment.

The depth data of an embodiment comprises three-dimensional point data of the plurality of structures.

The using the depth data comprises identifying structural elements of a hoistway at the installation site, under an embodiment.

The structural elements of an embodiment comprise a ceiling.

The structural elements of an embodiment comprise at least one wall.

The structural elements of an embodiment comprise at least one beam.

The structural elements of an embodiment comprise at least one rope.

The at least one measurement of an embodiment comprises a measurement of the hoistway.

The least one measurement of an embodiment comprises a beam height.

The at least one measurement of an embodiment comprises a beam width.

The at least one measurement of an embodiment comprises a beam to beam distance.

The at least one measurement of an embodiment comprises a beam edge to rope center distance.

The at least one measurement of an embodiment comprises a rope to rope distance.

The at least one measurement of an embodiment comprises a rope to wall distance.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The apparatus, systems, and methods for collecting and analyzing field measurement data can be a component of a single system, multiple system, and/or geographically separate systems. The apparatus, systems, and methods for collecting and analyzing field measurement data can also be a subcomponent or subsystem of a single system, multiple systems, and/or geographically separate systems. The components of an apparatus, systems, and methods for collecting and analyzing field measurement data can be coupled to one or more other components (not shown) of a host system or a system coupled to the host system.

One or more components of the apparatus, systems, and methods for collecting and analyzing field measurement data and/or a corresponding interface, system or application to which the apparatus, systems, and methods for collecting and analyzing field measurement data is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include the apparatus, systems, and methods for collecting and analyzing field measurement data can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the apparatus, systems, and methods for collecting and analyzing field measurement data and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the apparatus, systems, and methods for collecting and analyzing field measurement data and corresponding systems and methods include: microcontrollers with memory (such as electronically erasable programmable read only memory (EEPROM)), embedded microprocessors, firmware, software, etc. Furthermore, aspects of the apparatus, systems, and methods for collecting and analyzing field measurement data and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the apparatus, systems, and methods for collecting and analyzing field measurement data is not intended to be exhaustive or to limit the systems and methods to the precise forms disclosed. While specific embodiments of, and examples for, the apparatus, systems, and methods for collecting and analyzing field measurement data and corresponding systems and methods are described herein for illustrative purposes, various equivalent modifications are possible within the scope of the systems and methods, as those skilled in the relevant art will recognize. The teachings of the apparatus, systems, and methods for collecting and analyzing field measurement data and corresponding systems and methods provided herein can be applied to other systems and methods, not only for the systems and methods described above.

The elements and acts of the various embodiments described above can be combined to provide further embodiments. These and other changes can be made to the apparatus, systems, and methods for collecting and analyzing field measurement data and corresponding systems and methods in light of the above detailed description.

What is claimed is:

1. A system comprising,
one or more applications running on one or more processors of a remote server and a mobile application running on at least one processor of a mobile device, wherein the one or more applications are communicatively coupled with the mobile application, wherein the mobile device comprises an optical sensor;
the mobile application for controlling the optical sensor in capturing a plurality of structures at an installation site, wherein the capturing includes aiming the optical sensor at the plurality of structures and scanning the plurality of structures, wherein the capturing detects depth data of the plurality of structures;
the mobile application configured to transmit the depth data of the plurality of structures to the one or more applications;
the one or more applications configured to use the depth data for creating a three-dimensional electronic image of the plurality of structures;
the one or more applications for presenting the three-dimensional electronic image of the plurality of structures through an electronic interface;
the one or more applications for providing an electronic measurement tool for generating at least one distance measurement from a first point of the presented three-dimensional electronic image to a second point of the presented three-dimensional electronic image;
the one or more applications for using the at least one measurement to identify equipment for installation at the installation site.

2. The system of claim 1, wherein the capturing includes the mobile application instructing a directional positioning of the optical sensor by presenting visual direction through a mobile device electronic interface.

3. The system of claim 1, wherein the depth data comprises three-dimensional point data of the plurality of structures.

4. The system of claim 3, wherein the using the depth data comprises identifying structural elements of a hoistway at the installation site.

5. The system of claim 4, wherein the structural elements comprise a ceiling.

6. The system of claim 4, wherein the structural elements comprise at least one wall.

7. The system of claim 4, wherein the structural elements comprise at least one beam.

8. The system of claim 4, wherein the structural elements comprise at least one rope.

9. The system of claim 4, wherein the at least one measurement comprises a measurement of the hoistway.

10. The system of claim 9, wherein the at least one measurement comprises a beam height.

11. The system of claim 9, wherein the at least one measurement comprises a beam width.

12. The system of claim 9, wherein the at least one measurement comprises a beam to beam distance.

13. The system of claim 9, wherein the at least one measurement comprises a beam edge to rope center distance.

14. The system of claim 9, wherein the at least one measurement comprises a rope to rope distance.

15. The system of claim 9, wherein the at least one measurement comprises a rope to wall distance.
